(19) United States
(12) Patent Application Publication
(10) Pub. No.: US 2026/0222637 A1
(43) Pub. Date: Jul. 30, 2026

(54) ITERATIVE OPTIMIZATION TECHNIQUES FOR GENERATING ENCODING LADDERS FOR VIDEO STREAMING

(71) Applicant: NETFLIX, INC., Los Gatos, CA (US)

(72) Inventors: Renata Cruz TEIXEIRA, New York, NY (US); Kyle Christopher SWANSON, Los Gatos, CA (US); Xiaoqing ZHU, Austin, TX (US)

(21) Appl. No.: 19/424,007

(22) Filed: Dec. 17, 2025

Related U.S. Application Data
(60) Provisional application No. 63/751,686, filed on Jan. 30, 2025.

(51) Int. Cl. H04N 21/2385; H04N 21/2383; H04N 21/24; H04N 21/2662

(52) U.S. Cl. CPC H04N 21/2385; H04N 21/2383; H04N 21/2402; H04N 21/2662

(57) ABSTRACT

In various embodiments, one or more encoding operations are performed on a source video corresponding to a media title to generate encoded videos. Candidate rungs are generated based on the encoded videos. An integer linear programming (ILP) algorithm is executed on a first ILP problem and the candidate rungs to generate a first candidate encoding ladder, where the first ILP problem is based on a first set of parameter values, a parameterized objective function, and parameterized constraints. A second set of parameter values is generated based on the first candidate encoding ladder and the first set of parameter values. The ILP algorithm is executed on a second ILP problem and the candidate rungs to generate a second candidate encoding ladder, where the second ILP problem is based on the second set of parameter values, the parameterized objective function, and the parameterized constraints.

### CROSS-REFERENCE TO RELATED APPLICATIONS

This application claims priority benefit of the United States Provisional Patent Application titled, “NESTED ITERATIVE OPTIMIZATION FOR VIDEO BITRATE LADDER CONSTRUCTION,” filed on Jan. 30, 2025, and having Ser. No. 63/751,686. The subject matter of this related application is hereby incorporated herein by reference.

### BACKGROUND

### Field of the Various Embodiments

The various embodiments relate generally to computer science and media encoding and streaming technologies and, more specifically, to iterative optimization techniques for generating encoding ladders for video streaming.

### Description of the Related Art

A typical video streaming service provides users with access to a library of media titles that can be viewed on a wide range of different endpoint devices. In operation, a given endpoint device connects to the video streaming service under a variety of connection conditions and, therefore, can be susceptible to differing network throughputs. In an effort to ensure that a given media title can be streamed to an endpoint device without playback interruptions, a video streaming service normally generates an encoding ladder for the media title. Each rung of the encoding ladder specifies a different encoded video for the media title, the resolution of the encoded video, and the bitrate of the encoded video. Notably, an encoded video having a given bitrate can be streamed to an endpoint device without playback interruptions when the network throughput is greater than that bitrate. As the bitrate of an encoded video for a given media title that is streamed to an endpoint device increases, the visual quality of the media title as presented on the endpoint device usually increases as well.

In practice, the encoded videos specified in the encoding ladders for a library of media titles are normally delivered to endpoint devices via a content delivery network (CDN), where each server in the CDN has limited storage and a limited network throughput. Accordingly, generating an encoding ladder for a media title usually involves making tradeoffs between a streaming QoE (quality of experience) associated with the encoding ladder and a CDN efficiency associated with the encoding ladder. As used herein, a “streaming QoE” associated with an encoding ladder for a media title refers to an overall QoE for viewers when the encoding ladder is used to stream the media title to endpoint devices. In general, the streaming QoE is a multi-dimensional metric that takes into account different aspects of an overall viewing experience, such as, and without limitation, visual quality, playback stalls, and startup delay. In practice, the streaming QoE usually correlates to the overall visual quality of the media title as streamed to and presented on endpoint devices. As used herein, a “CDN efficiency” associated with a given encoding ladder refers to an overall effectiveness of a CDN when delivering an encoded media title to one or more endpoint devices in accordance with the encoding ladder. In general, CDN efficiency is a multi-dimensional metric that takes into account different aspects of effective delivery, such as, and without limitation, the data volume transferred from a CDN to one or more endpoint devices when streaming an encoded media title and an overall storage footprint of the encoding ladder generated for the media title. In practice, the CDN efficiency usually correlates to the overall storage footprint of the encoding ladder for the media title.

In one approach to generating an encoding ladder for a media title, the encoding ladder is incrementally constructed based on heuristics corresponding to a set of ladder constraints. Collectively, the ladder constraints are designed to ensure that requisite streaming QoEs and requisite CDN efficiencies can be achieved when the media title is transmitted to a variety of endpoint devices over networks having a wide range of throughputs. To generate a given encoding ladder for a media title, a relatively large number of different encoded videos representing many different combinations of resolution and bitrate are produced based on a source video of the media title. Starting from an initially empty encoding ladder, the heuristic for each ladder constraint is sequentially executed on the encoding ladder based on the different encoded videos, where the heuristic for a given ladder constraint determines whether the encoding ladder already complies with the ladder constraint. If the encoding ladder already complies with the ladder constraint, then the heuristic does not modify the encoding ladder. Otherwise, the heuristic adds at least one encoded video to the encoding ladder in order to bring the encoding ladder into compliance with that particular ladder constraint.

One drawback of the above approach is that, because the ladder constraints are enforced one-at-a-time, and no encoded video is ever removed from the encoding ladder, the streaming QoE/CDN efficiency tradeoff represented by the encoding ladder can be sub-optimal. More specifically, because ladder constraints are enforced sequentially, opportunities to intentionally select a single encoded video that satisfies multiple ladder constraints in order to improve the streaming QoE/CDN efficiency tradeoff can be missed. In such cases, the average visual quality of the media title achieved using the different encoded videos specified in the encoding ladder can be unnecessarily low given the total storage footprint of the encoding ladder. Conversely, the total storage footprint of the encoding ladder can be unnecessarily large given the average visual quality of the media title achieved using the different encoded videos specified in the encoding ladder.

As the foregoing illustrates, what is needed in the art are more effective techniques for generating encoding ladders for video streaming.

### SUMMARY

One embodiment sets forth a computer-implemented method for generating encoding ladders that are used to stream media titles. The method includes performing one or more encoding operations on a source video corresponding to a first media title to generate a set of encoded videos; generating a set of candidate rungs based on the set of encoded videos; executing an integer linear programming (ILP) algorithm on a first ILP problem and the set of candidate rungs to generate a first candidate encoding ladder, where the first ILP problem is based on a first set of parameter values for a set of parameters, a parameterized objective function, and a set of parameterized constraints; generating a second set of parameter values for the set of parameters based on the first candidate encoding ladder and the first set of parameter values; and executing the ILP algorithm on a second ILP problem and the set of candidate rungs to generate a second candidate encoding ladder, where the second ILP problem is based on the second set of parameter values, the parameterized objective function, and the set of parameterized constraints.

At least one technical advantage of the disclosed techniques relative to the prior art is that, with the disclosed techniques, different candidate encoding ladders for a media title can be iteratively generated based an overall objective of increasing both a streaming QoE and a CDN efficiency while concurrently accounting for different ladder constraints when generating each candidate encoding ladder in the first instance. With such an approach, opportunities to use a single encoded video that satisfies multiple different ladder constraints are automatically identified and exploited when generating each candidate encoding ladder, which can improve the tradeoff between the average visual quality of the media title that is achieved when using the encoded videos specified in the candidate encoding ladder and the total storage footprint of the candidate encoding ladder. Consequently, a streaming QoE/CDN efficiency tradeoff represented by a candidate encoding ladder for a given media title can be substantially improved relative to what can be achieved using prior art techniques. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a conceptual illustration of a system configured to implement one or more aspects of the various embodiments;

FIG. 2 is a more detailed illustration of the candidate encoding ladder generator of FIG. 1, according to various embodiments; and

FIG. 3 is a flow diagram of method steps for generating an encoding ladder for a media title, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details. For explanatory purposes, multiple instances of like objects are symbolized with reference numbers identifying the object and parenthetical alphanumeric character(s) identifying the instance where needed.

An encoded video having a given bitrate can typically be streamed to an endpoint device without playback interruptions when the available network bandwidth is greater than that bitrate. In an effort to ensure that a given media title can be streamed to an endpoint device without playback interruptions, a video streaming service normally generates an encoding ladder for the media title. Each rung of the encoding ladder specifies a different encoded video for the media title, the resolution of the encoded video, and the bitrate of the encoded video. In practice, the encoded videos specified in the encoding ladders for a library of media titles are normally delivered to endpoint devices via a CDN. Because each server in the CDN has limited storage and a limited network throughput, generating an encoding ladder for a media title usually involves making tradeoffs between a streaming QoE associated with the encoding ladder and a CDN efficiency associated with the encoding ladder.

In one approach to generating an encoding ladder for a media title, the encoding ladder is incrementally constructed based on heuristics corresponding to a set of ladder constraints and a relatively large number of different encoded videos for the media title. The set of ladder constraints are collectively designed to ensure that requisite streaming QoEs and requisite CDN efficiencies can be achieved when the media title is transmitted to a variety of endpoint devices over networks having a wide range of throughputs. The different encoded videos represent many different combinations of resolution and bitrate. The heuristic for each ladder constraint is sequentially executed on an initially empty encoding ladder based on the different encoded videos, where the heuristic for a given ladder constraint determines whether the encoding ladder already complies with the ladder constraint. If the encoding ladder already complies with the ladder constraint, then the heuristic does not modify the encoding ladder. Otherwise, the heuristic adds at least one encoded video to the encoding ladder in order to bring the encoding ladder into compliance with that particular ladder constraint.

One drawback of the above approach is that, because the ladder constraints are enforced one-at-a-time, and no encoded video is ever removed from the encoding ladder, the streaming QoE/CDN efficiency tradeoff represented by the encoding ladder can be sub-optimal. More specifically, because ladder constraints are enforced sequentially, opportunities to intentionally select a single encoded video that satisfies multiple ladder constraints in order to improve the streaming QoE/CDN efficiency tradeoff can be missed.

With the disclosed techniques, however, an encoding ladder generation application iteratively generates multiple candidate encoding ladders for a media title based on an overall goal of increasing both a streaming QoE and a CDN efficiency while concurrently accounting for different ladder constraints when generating each candidate encoding ladder in the first instance. Notably, the number of rungs can vary across the candidate encoding ladders and each of the candidate encoding ladders represents a different streaming QoE/CDN efficiency tradeoff. The encoding ladder generation application ranks the candidate encoding ladders based on one or more weighted criteria that are relevant to streaming QoE and one or more weighted criteria that are relevant to CDN efficiency. The weights of the criteria reflect the relative importance of each criteria. The ladder selection application designates the highest ranked candidate encoding ladder as an encoding ladder that should be used to stream the media title.

At least one technical advantage of the disclosed techniques relative to the prior art is that, with the disclosed techniques, the encoding ladder application concurrently satisfies the ladder constraints when generating each candidate encoding ladder. Unlike some prior art techniques, the encoding ladder application therefore automatically identifies and exploits opportunities to use a single encoded video to satisfy multiple different ladder constraints and improve the streaming QoE/CDN efficiency tradeoff. Consequently, the streaming QoE/CDN efficiency tradeoff represented by a candidate encoding ladder for a given media title can be substantially improved relative to what can be achieved using prior art techniques. These technical advantages provide one or more technological improvements over prior art approaches.

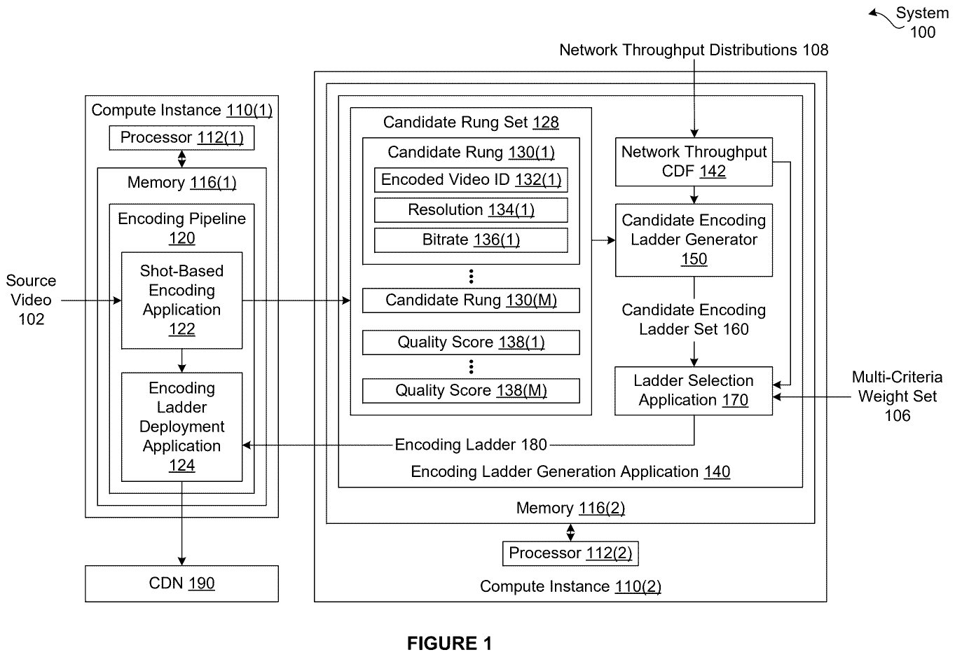

FIG. 1 is a conceptual illustration of a system 100 configured to implement one or more aspects of the various embodiments. For explanatory purposes, multiple instances or versions of like objects are denoted with reference numbers identifying the object and parenthetical alphanumeric character(s) identifying the instance or version where needed. As shown, in some embodiments, the system 100 includes, without limitation, a compute instance 110(1), a compute instance 110(2), and a CDN 190.

In some other embodiments, the system 100 can omit the compute instance 110(1) and/or the CDN 190. In the same or other embodiments, the system 100 can include, without limitation, one or more other compute instances, one or more other historical streaming session databases, or any combination thereof. The components of the system 100 can be distributed across any number of shared geographic locations and/or any number of different geographic locations and/or implemented in one or more cloud computing environments (i.e., encapsulated shared resources, software, data, etc.) in any combination.

As shown, the compute instance 110(1) includes, without limitation, a processor 112(1) and a memory 116(1), and the compute instance 110(2) includes, without limitation, a processor 112(2) and a memory 116(2). The compute instance 110(1) and the compute instance 110(2) are also referred to herein individually as “the compute instance 110” and collectively as “the compute instances 110.” The processor 112(1) and the processor 112(2) are also referred to herein individually as “the processor 112” and collectively as “the processors 112.” The memory 116(1) and the memory 116(2) are also referred to herein individually as “the memory 116” and collectively as “the memories 116.” Each compute instance (including the compute instances 110) can be implemented in a cloud computing environment, implemented as part of any other distributed computing environment, or implemented in a stand-alone fashion.

The processor 112 can be any instruction execution system, apparatus, or device capable of executing instructions. For example, the processor 112 could comprise a central processing unit, a graphics processing unit, a controller, a micro-controller, a state machine, or any combination thereof. The memory 116 of the compute instance 110 stores content, such as software applications and data, for use by the processor 112 of the compute instance 110. The memory 116 can be one or more of a readily available memory, such as random-access memory, read only memory, floppy disk, hard disk, or any other form of digital storage, local or remote.

In some other embodiments, any number of compute instances can include any number of processors and any number of memories in any combination. In particular, the compute instance 110(1), the compute instance 110(2), any number of other compute instances, or any combination thereof can provide a multiprocessing environment in any technically feasible fashion.

In some embodiments, a storage (not shown) may supplement or replace the memory 116 of the compute instance 110. The storage may include any number and type of external memories that are accessible to the processor 112 of the compute instance 110. For example, and without limitation, the storage can include a Secure Digital Card, an external Flash memory, a portable compact disc read-only memory, an optical storage device, a magnetic storage device, or any suitable combination of the foregoing

In general, each compute instance (including the compute instances 110) is configured to implement one or more software applications. For explanatory purposes only, each software application is described as residing in the memory 116 of a single compute instance and executing on the processor 112 of the same compute instance. However, in some embodiments, the functionality of each software application can be distributed across any number of other software applications that reside in the memories of any number of compute instances and execute on the processors of any number of compute instances in any combination. Further, the functionality of any number of software applications can be consolidated into a single software application.

In particular, in some embodiments, an encoding pipeline 120 resides in the memory 116(1) of the compute instance 110(1) and executes on the processor 112(1) of the compute instance 110(1). As shown, the encoding pipeline 120 includes, without limitation, a shot-based encoding application 122 and an encoding ladder deployment application 124.

The shot-based encoding application 122 partitions a source video 102 that corresponds to a media title into shots (not shown). The source video 102 includes, without limitation, any amount and/or types of video content. Some examples of video content include, without limitation, any portion (including all) of feature length films, episodes of television programs, and music videos, to name a few. Each shot includes a sequence of frames that usually have similar spatial-temporal properties and run for an uninterrupted period of time. In some embodiments, each shot is captured continuously from a single camera or virtual representation of a camera (e.g., in the case of computer animated videos). Together, the shots span the length of the source video 102 in a contiguous, non-overlapping fashion.

The shot-based encoding application 122 downscales each of the shots to multiple different resolutions to generate lower-resolution shots. The shot-based encoding application 122 encodes each of the shots and each of the lower-resolution shots across different sets of one or more values for a set of one or more encoding parameters to generate encoded shots having different combinations of resolutions and bitrates. The shot-based encoding application 122 computes a bitrate and a quality score for each encoded shot.

As used herein, the bitrate of an encoded sequence of frames (e.g., an encoded shot or an encoded video) refers to an average bitrate across the encoded sequence of frames. The quality score of an encoded sequence of frames refers to a quality score of a reconstructed sequence of frames derived from the encoded sequence of frames. And the quality score of a reconstructed sequence of frames refers to an average estimated visual quality level across the reconstructed sequence of frames. In some embodiments, an average estimated visual quality level across a reconstructed sequence of frames is computed using a harmonic mean.

A quality score can be a value for any type of metric that correlates to visual quality in any technically feasible fashion. In some embodiments, each quality score is a value for a visual quality metric. Some examples of visual quality metrics include, without limitation, a peak signal-to-noise-ratio (PSNR), and a video multimethod assessment fusion (VMAF) metric. The VMAF metric estimates human-perceived video quality of reconstructed video content (e.g., the reconstructed shots, reconstructed videos, etc.).

For each resolution, the shot-based encoding application 122 generates a convex hull (not shown) of video bitrate-quality points based on the encoded shots having that resolution. Each of the video bitrate-quality points specifies an encoded video, the resolution of the encoded video, the bitrate of the encoded video, and the quality score for the encoded video.

To generate the convex hull for a given resolution, the shot-based encoding application 122 performs optimization operations based on the bitrates and the quality scores of the encoded shots having the resolution to aggregate the encoded shots into encoded videos having the resolution. For the resolution, each of the encoded videos is associated with the highest quality score for a different bitrate. The shot-based encoding application 122 generates a different video rate-quality point for each of the resulting encoded videos to determine the convex hull for the resolution.

Subsequently, the shot-based encoding application 122 generates an overall convex hull of video bitrate-quality points based on the convex hulls for the different resolutions. Each of the encoded videos specified via the overall convex hull is associated with the highest quality score for the corresponding bitrate. The overall convex hull therefore specifies any number (including none) of encoded videos having each resolution. An encoding ladder is generated based on the encoded videos included in the overall convex hull, the associated resolutions, the associated bitrates, and the associated quality scores.

The encoding ladder deployment application 124 transmits the encoded videos specified in the encoding ladder for the media title to the CDN 190 for subsequent delivery from any number of server devices included in the CDN 190 to any number of endpoint devices (not shown). The encoding ladder deployment application 124 also transmits the encoding ladder for the media title to a playback server (not shown) that subsequently enables endpoint devices to request portions or “chunks” of encoded videos from a proximate server in the CDN 190 based on the encoding ladder and an available network throughput to affect streaming of the media title.

As described previously herein, in one conventional approach to generating an encoding ladder for a media title, the encoding ladder is incrementally constructed based on heuristics corresponding to a set of ladder constraints and encoded videos representing many different combinations of resolution and bitrate (e.g., the encoded videos included in the convex hull). The heuristic for each ladder constraint is sequentially executed on an initially empty encoding ladder based on the different encoded videos, where the heuristic for a given ladder constraint determines whether the encoding ladder already complies with the ladder constraint. If the encoding ladder already complies with the ladder constraint, then the heuristic does not modify the encoding ladder. Otherwise, the heuristic adds at least one encoded video to the encoding ladder in order to bring the encoding ladder into compliance with that particular ladder constraint.

One drawback of the above approach is that, because the ladder constraints are enforced one-at-a-time, and no encoded video is ever removed from the encoding ladder, the streaming QoE/CDN efficiency tradeoff represented by the encoding ladder can be sub-optimal. More specifically, because ladder constraints are enforced sequentially, opportunities to intentionally select a single encoded video that satisfies multiple ladder constraints in order to improve the streaming QoE/CDN efficiency tradeoff can be missed.

### Generating Encoding Ladders Using Iterative Optimization Techniques

To address the above problem, the system 100 includes, without limitation, an encoding ladder generation application 140 that uses iterative optimization techniques to generate an encoding ladder 180 for the media title corresponding to the source video 102. The encoding ladder generation application 140 generates the encoding ladder 180 based on the overall convex hull of video bitrate-quality points generated by the shot-based encoding application 122, network throughput distributions 108, and a multi-criteria weight set 106.

As shown, the encoding ladder generation application 140 resides in the memory 116(2) of the compute instance 110(2) and executes on the processor 112(2) of the compute instance 110(2). The encoding ladder generation application 140 includes, without limitation, a candidate rung set 128, a network throughput cumulative distribution function (CDF) 142, a candidate encoding ladder generator 150, and a ladder selection application 170. The encoding ladder generation application 140 generates the candidate rung set 128 based on the overall convex hull and associated quality scores generated by the shot-based encoding application 122.

As shown, the candidate rung set 128 includes, without limitation, a candidate rung 130(1)—a candidate rung 130(M) and a quality score 138(1)—a quality score 138(M), where M can be any positive integer. As used herein, a “candidate rung” refers to a possible rung for the encoding ladder 180. A rung for an encoding ladder is also commonly referred to as a “ladder rung.” The candidate rung 130(1) specifies an encoded video ID 132(1), a resolution 134(1), and a bitrate 136(1). The encoded video ID 182(1) identifies an encoded video for the source video 102. The resolution 134(1), the bitrate 136(1), and the quality score 138(1) specify, respectively, the resolution, the bitrate, and the quality score of the encoded video corresponding to the encoded video ID 132(1). Although not explicitly shown, each of the candidate rung 130(2)—the candidate rung 130(M) specifies a different encoded video ID and a resolution and a bitrate of an encoded video corresponding to that encoded video ID. The quality score 138(2)—the quality score 138(M) specify quality scores for encoded videos corresponding to the encoded video IDs included in, respectively, the candidate rung 130(2)—the candidate rung 130(M).

For explanatory purposes, the candidate rung 130(1)—the candidate rung 130(M) are also referred to herein collectively as “candidate rungs 130” and individually as a “candidate rung 130.” The quality score 138(1)—a quality score 138(M) are also referred to herein collectively as “quality scores 138” and individually as a “quality score 138.”

As shown, the encoding ladder generation application 140 computes the network throughout CDF 142 based on the network throughput distributions 108. The network throughput CDF 142 is a CDF of network throughput. In some embodiments, each of the network throughput distributions 108 includes recorded measurements of a network throughput as a function of time over the duration of a different streaming session. The network throughput distributions 108 can be associated with any number of past streaming sessions for any number of media titles. In some alternate embodiments, each of the network throughput distributions 108 is synthesized by a software application in any technically feasible fashion. The network throughout CDF 142 is denoted herein as F(⋅).

As shown, the candidate encoding ladder generator 150 generates a candidate encoding ladder set 160 based on the candidate rung set 128 and the network throughput CDF 142. The candidate encoding ladder set 160 includes one or more candidate encoding ladders (not shown) for the media title. As used herein, a “candidate encoding ladder” for a media title refers to any encoding ladder that can be used as an encoding ladder for the media title. Each of the candidate encoding ladders included in the candidate encoding ladder set 160 includes, without limitation, a different subset of the candidate rungs 130.

The candidate encoding ladder generator 150 implements an iterative ladder optimization process to address a multi-objective optimization problem with an overall objective of increasing both a streaming QoE and a CDN efficiency while concurrently accounting for different constraints when generating each of the candidate encoding ladders. A constraint associated with generating any number and/or types of encoding ladders (e.g., a candidate encoding ladder, the encoding ladder 180) is also referred to herein as a “ladder constraint.” Each constraint can include zero or more parameters. A constraint that includes at least one parameter is also referred to herein as a “parameterized constraint.” As described in greater detail below, the candidate encoding ladder generator 150 generates each of the candidate encoding ladders during a different iteration.

In some embodiments, the objectives of the multi-objective optimization problem are to increase an expected streaming quality, decrease a top quality difference with respect to certain target values, decrease a total storage footprint, and decrease an expected streaming rate. As described in greater detail below, the expected streaming quality and the top quality difference are streaming QoE metrics. As persons skilled in the art will recognize, increasing the expected streaming quality and decreasing the top quality difference increases the streaming QoE. The total storage footprint and the expected streaming rate are CDN efficiency metrics. Decreasing the total storage footprint and decreasing the expected streaming rate increases the CDN efficiency when streaming the media title associated with the source video 102. The multiple objectives can be expressed as an equation (1):

$${max}_{X} ( E [ Q ( X ) ] , - Δ Qtop ( X ) , - S ( X ) , - E [ R ( X ) ] ) \qquad ( 1 )$$

In equation (1) and below, X denotes an indicator matrix (not shown) that defines a candidate encoding ladder. E[Q(X)] denotes an expected streaming quality for the candidate encoding ladder corresponding to X. ΔQtop(X) denotes the top quality difference for the candidate encoding ladder corresponding to X. S(X) denotes a total storage footprint for the candidate encoding ladder corresponding to X. E[R(X)] denotes an expected streaming rate for the candidate encoding ladder corresponding to X.

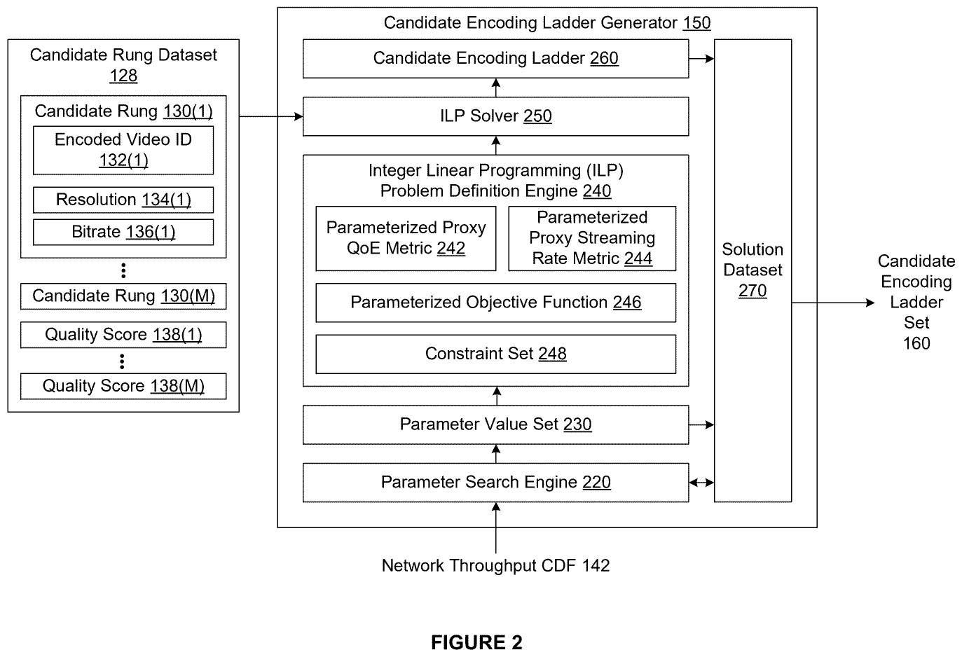

Each of the candidate encoding ladders included in the encoding ladder set 160 corresponds to a different indicator matrix (not shown). The indicator matrices facilitate the generation of the candidate encoding ladder set 160. Each indicator matrix specifies the subset of the candidate rungs 130 that are to be included in a corresponding candidate encoding ladder. More specifically, each indicator matrix is an M×N Boolean matrix that is denoted herein as X, where N denotes a rung count parameter. A “rung count” is also referred to herein as a “number of rungs.” As described in greater detail below in conjunction with FIG. 2, the value for the rung count parameter can vary across iterations. Accordingly, the size of the indicator matrix and the total number of rungs that are included in each candidate encoding ladder can vary across iterations.

The rows 1-M of X correspond, respectively, to the candidate rung 130(1)—the candidate rung 130(M). The columns of X correspond to a rung 1—a rung N of a corresponding candidate encoding ladder. The symbol X_{i,j} denotes the element in the i^{th} row and the jₜₕ column of the indicator matrix. If X_{i,j} is 1, then the candidate rung 130(i) is assigned to the rung j of the candidate encoding ladder corresponding to X. If X_{i,j} is 0, then the candidate rung 130(i) is not assigned to the rung j of the candidate encoding ladder corresponding to X.

As described in greater detail below in conjunction with FIG. 2, rung assignments are constrained such that bitrates specified via the rung 1 through the rung N of a candidate encoding ladder increase monotonically. For explanatory purposes, rung 1 and rung N of a candidate encoding ladder are also referred to herein as a “lowest rung” and a “highest rung” of the candidate encoding ladder.

For explanatory purposes, the symbols r_{i,}, q_{i,}, and hᵢ denote, respectively, the bitrate, the quality score, and the resolution of the candidate rung 130(i). The symbols R_{j,}, Q_{j,}, and Hⱼ denote, respectively, the bitrate, the quality score, and the resolution of the rung j of the candidate encoding ladder corresponding to the indicator matrix X.

The expected streaming quality for a candidate encoding ladder is the probability-weighted average quality score across all rungs of the candidate encoding ladder, where weights from the network throughput CDF 142 indicate the likelihood of streaming at each rung. The expected streaming quality for a candidate encoding ladder corresponding to X can be expressed as an equation (2):

$$E [ Q ( X ) ] = {\sum }_{j = 1}^{N} ( F ( {R}_{j + 1} ) - F ( {R}_{j} ) ) {Q}_{j} \qquad ( 2 )$$

The top quality difference for a candidate encoding ladder is the difference between a value for a target high quality parameter and the highest quality score associated with the candidate encoding ladder. The target top quality parameter is denoted herein as Qtoptarget and does not vary across iterations. The highest quality score associated with a candidate encoding ladder is the quality score QN corresponding to rung N of the candidate encoding ladder. As persons skilled in the art will recognize, a majority of streaming a media title typically occurs at the highest quality available for the media title. Accordingly, reducing the top quality difference usually increases streaming QoE. The top quality difference for a candidate encoding ladder corresponding to X can be expressed as an equation (3):

$$Δ Q t o p ( X ) = Qtoptarget - {Q}_{N} \qquad ( 3 )$$

As persons skilled in the art will recognize, the expected streaming quality and the top quality difference reflect overall visual quality aspects of streaming QoE but do not reflect other aspects of streaming QoE, such as playback delay, stalls, and quality changes. To address some other aspects of streaming QoE, the candidate encoding ladder generator 150 concurrently accounts for any number and/or types of constraints (not shown in FIG. 1) that are designed to ensure requisite streaming QoEs across different endpoint devices and network conditions when generating each of the candidate encoding ladders. Constraints designed to ensure requisite streaming QoEs and various other constraints that the candidate encoding ladder generator 150 concurrently accounts for when generating each candidate encoding ladder are described in greater detail below in conjunction with FIG. 2.

The total storage footprint for a candidate encoding ladder quantifies the amount of storage required to store the encoded videos specified in the rungs of the candidate encoding ladder. The total storage footprint of a candidate encoding ladder associated with a media title is the product of the duration of the media title (denoted herein as T) and the sum of the bitrates of the rungs of the candidate encoding ladder. The total storage footprint for a candidate encoding ladder for a candidate encoding ladder corresponding to X can be expressed as an equation (4):

$$S ( X ) = {\sum }_{j = 1}^{N} {R}_{j} T \qquad ( 4 )$$

The expected streaming rate for a candidate encoding ladder is the probability-weighted average of bitrates across all rungs of the candidate encoding ladder, where weights from the network throughput CDF 142 indicate the likelihood of streaming at each rung. The expected streaming rate for a candidate encoding ladder corresponding to X can be expressed as an equation (5):

$$E [ R ( X ) ] = {\sum }_{j = 1}^{N} ( F ( {R}_{j + 1} ) - F ( {R}_{j} ) ) {R}_{j} \qquad ( 5 )$$

As described in greater detail below in conjunction with FIG. 2, the candidate encoding ladder generator 150 iteratively defines and solves different integer linear programming (ILP) problems based on iteration-specific sets of parameter values for a set of parameters, a parameterized objective function, and a set of constraints to generate the candidate encoding ladder set 160. As used herein, a “parameter value” refers to a value of a parameter. The set of parameters can include, without limitation, any number and/or types of parameters that are relevant to the generation of a candidate encoding ladder. The set of constraints can include any number and/or types of parameterized constraints and any number and/or types of non-parameterized constraints, where each constraint can constrain any aspect associated with the generation of a candidate encoding ladder in any technically feasible fashion.

To define an ILP problem for an iteration, the candidate encoding ladder generator 150 generates a new objective function and an instantiated set of constraints based on a set of parameter values for the iteration, the parameterized objective function, and the set of constraints. As used herein, an “instantiated” set of constraints is a set of constraints for which the parameters have been replaced with parameter values. The candidate encoding ladder generator 150 then formulates the problem of generating a new candidate encoding ladder for the iteration as a constrained optimization problem of assigning a subset of the candidate rungs to rungs of the new candidate encoding ladder with an objective of increasing the new objective function subject to the instantiated set of constraints. The candidate encoding ladder generator 150 executes one or more ILP algorithms on the ILP problem, the candidate rungs 130, and the quality scores 136 in an attempt to solve the ILP problem, thereby generating a new candidate encoding ladder.

After generating each new candidate encoding ladder, the candidate encoding ladder generator 150 computes values for one or more streaming QoE metrics and one or more CDN efficiency metrics based on the candidate encoding ladder, the subset of the quality scores 138 that are associated with the candidate encoding ladder, and the network throughput CDF 142. To initiate a new iteration, the candidate encoding ladder generator 150 performs one or more search operations on a parameter space based on any number of previously generated candidate encoding ladders, associated metric values, and associated sets of parameter values. As used herein, a “metric value” refers to a value of a metric. The objective of the search operations is to find a new set of parameter values that will produce a new candidate encoding ladder on a Pareto front that balances streaming QoE and CDN efficiency. As persons skilled in the art will recognize, a Pareto front with respect to a multi-objective optimization problem is the set of solutions for which no solution is better than another across all objectives. If a solution is included in the Pareto front, then improving one objective would lead to a deterioration in at least one other objective.

Advantageously, generating candidate encoding ladders with an overall objective of increasing both a streaming QoE and a CDN efficiency while concurrently accounting for different constraints when generating each candidate encoding ladder in the first instance can improve the QoE/CDN efficiency tradeoff represented by each candidate encoding ladder relative to what can be achieved using prior art techniques. In particular, opportunities to use a single encoded video that satisfies multiple different constraints are automatically identified and exploited when generating each candidate encoding ladder, which can improve the tradeoff between the average visual quality of the media title that is achieved when using the encoded videos specified in the candidate encoding ladder and the total storage footprint of the candidate encoding ladder.

As shown, the ladder selection application 170 generates the encoding ladder 180 based on the candidate encoding ladder set 160, the network throughput CDF 142, and the multi-criteria weight set 106. In operation, the ladder selection application 170 implements one or more multi-criteria decision analysis techniques to rank the candidate encoding ladders included in the candidate encoding ladder set 160 based on multiple criteria weighed in accordance with the multi-criteria weight set 106. The multi-criteria weight set 106 includes, without limitation, a different weight for each of the multiple criteria, where the weights reflect the relative importance of the criteria. Any number of the criteria are computed based on the network throughput CDF 142.

In some embodiments, the multiple criteria include, without limitation, the expected streaming quality, the top quality difference, the total storage footprint, and the expected streaming bitrate. The ladder selection application 170 therefore ranks the candidate encoding ladders included in the candidate encoding ladder set 160 based on streaming QoE and CDN efficiency. As described above, the expected streaming quality, the top quality difference, the total storage footprint, and the expected streaming bitrate can be expressed as, respectively, the equation (2)-the equation (5). The multi-criteria weight set 106 includes, without limitation, a different weight for each of the expected streaming quality, the top quality difference, the total storage footprint, and the expected streaming bitrate

In the same or other embodiments, the ladder selection application 170 implements a multi-criteria decision analysis technique known as Technique for Order of Preference by Similarity to Ideal Solution (TOPSIS) to rank the candidate encoding ladders included in the candidate encoding ladder set 160. As persons skilled in the art will recognize, the ladder selection application 170 uses TOPSIS to identify the candidate encoding ladder closest to a positive ideal solution and farthest from a negative ideal solution. More precisely, the ladder selection application 170 uses TOPSIS to compute weighted distances from the positive ideal solution and the negative ideal solution based on the multiple criteria and the multi-criteria weight set 106.

The ladder selection application 170 determines that the highest ranked candidate encoding ladder should be used to stream the media title. The ladder selection application 170 therefore sets the encoding ladder 180 equal to the highest ranked candidate encoding ladder included in the candidate encoding ladder set 160. As shown, the ladder selection application 170 transmits the encoding ladder 180 to the encoding ladder deployment application 124 for deployment to any number of endpoint devices via the CDN 190.

The multi-criteria weight set 106 can be determined in any technically feasible fashion. For instance, in some embodiments, the multi-criteria weight set 106 is specified via a user interface. Advantageously, the ladder selection application 170 efficiently compares the candidate encoding ladders included in the candidate encoding ladder set 160 that each represent a different streaming QoE/CDN efficiency tradeoff to determine the encoding ladder 180 that represents a streaming QoE/CDN efficiency tradeoff that most closely reflects the importance of multiple criteria as per the multi-criteria weight set 106.

Note that the techniques described herein are illustrative rather than restrictive and may be altered without departing from the broader spirit and scope of the invention. Many modifications and variations on the functionality provided by the encoding pipeline 120, the shot-based encoding application 122, the encoding ladder deployment application 124, the CDN 190, the encoding ladder generation application 140, the candidate encoding ladder generator 150, and the ladder selection application 170 will be apparent to those of ordinary skill in the art without departing from the scope and spirit of the described embodiments.

In some embodiments, the shot-based encoding application 122 generates one or more video bitrate-quality points based on encoded videos and performs any number and/or types of extrapolation operations and/or interpolation operations based on the video bitrate-quality points to identify virtual bitrate-quality points that specify encoded videos that could potentially be generated from the source video 102. The encoding ladder generation application 140 generates the candidate rung set 128 based on a convex hull of video bitrate-quality points and virtual bitrate-quality points. In the same or other embodiments, the encoding ladder deployment application 124 can generate and/or regenerate any number of the encoded videos identified by the encoded ladder 180.

In some embodiments, the candidate encoding ladder generator 150 can implement any type of parameterized objective function that includes one or more terms related to streaming QoE and one or more terms related to CDN efficiency, and the techniques described herein are modified accordingly. In the same or other embodiments, the candidate encoding ladder generator 150 can generate a new set of parameter values for each non-initial iteration based on any number and/or types of aspects of any previously generated candidate encoding ladders and the associated sets of parameter values in any technically feasible fashion.

Many modifications and variations on the organization, amount, and/or types of data described herein will be apparent to those of ordinary skill in the art without departing from the scope and spirit of the described embodiments. For instance, in some embodiments, each of the candidate rungs 130, each rung of each candidate encoding ladder, each rung of the encoding ladder 180, or any combination thereof can specify a quality score in addition to the bitrate and the resolution of an encoded video specified via the encoded video ID.

It will be appreciated that the system 100 shown herein is illustrative and that variations and modifications are possible. For example, the functionality provided by encoding pipeline 120, the shot-based encoding application 122, the encoding ladder deployment application 124, the CDN 190, the encoding ladder generation application 140, the candidate encoding ladder generator 150, and the ladder selection application 170 as described herein can be integrated into or distributed across any number of software applications (including one), and any number of components of the system 100. Further, the connection topology between the various units in FIG. 1 can be modified as desired.

### Iteratively Generating Candidate Encoding Ladders

FIG. 2 is a more detailed illustration of the candidate encoding ladder generator 150 of FIG. 1, according to various embodiments. As described previously herein in conjunction with FIG. 1, the candidate encoding ladder generator 150 generates a candidate encoding ladder set 160 based on the candidate rung set 128 and the network throughput CDF 142.

As described previously herein in conjunction with FIG. 1, the candidate rung set 128 includes, without limitation, the candidate rung 130(1)—the candidate rung 130(M) and the quality score 138(1)—the quality score 138(M). Each of the candidate rung 130(1)—the candidate rung 130(M) specifies a different encoded video ID and a resolution and a bitrate of an encoded video corresponding to that encoded video ID. The quality score 138(1)—the quality score 138(N) specify quality scores for encoded videos corresponding to the encoded video IDs included in, respectively, the candidate rung 130(1)—the candidate rung 130(M).

Referring back to FIG. 1, the candidate encoding ladder set 160 includes one or more candidate encoding ladders (not shown) for the media title corresponding to the source video 102. Each of the candidate encoding ladders included in the candidate encoding ladder set 160 includes, without limitation, a different subset of the candidate rungs 130. The number of rungs can vary across the candidate encoding ladders.

The candidate encoding ladder generator 150 formulates the problem of generating the candidate encoding ladder set 160 as an iterative parameterized ILP problem. As persons skilled in the art will recognize, an ILP problem is a type of optimization for which the variables are integer values, the objective function is linear with respect to the variables, and each of the constraints is constant or linear with respect to the variables. Notably, the variables of the iterative parameterized ILP problem formulated by the candidate encoding ladder generator 150 are the entries of an indicator matrix (described previously herein in conjunction with FIG. 1). As used herein a “parameterized” ILP problem is a generalized version of an ILP problem that is expressed in terms of at least one parameter. An “iterative” parameterized ILP problem is a parameterized ILP problem for which a set of values for a set of parameters associated with the parameterized ILP problem varies across each of any number of iterations.

As shown, the candidate encoding ladder generator 150 includes, without limitation, a parameter search engine 220, a parameter value set 230, an ILP problem definition engine 240, an ILP solver 250, a candidate encoding ladder 160, and a solution dataset 270. Every iteration, the parameter search engine 220 generates a new version of the parameter value set 230 and the ILP solver 250 attempts to generate a new version of the candidate encoding ladder 260 that corresponds to the new version of the parameter value set 230. A new version of the parameter value set 230 is also referred to herein as a “new parameter value set.” A new version of the candidate encoding ladder 260 is also referred to herein as a “new candidate encoding ladder.”

Prior to an initial iteration, the candidate encoding ladder generator 150 sets the solution dataset 270 equal to an empty set. To complete each iteration, the candidate encoding ladder generator 150 determines whether the ILP solver 250 successfully generated a new version of the candidate encoding ladder 260 based on a new version of the parameter value set 250. If the ILP solver 250 successfully generated a new version of the candidate encoding ladder 260 based on a new version of the parameter value set 250, then the candidate encoding ladder generator 150 stores the new version of the candidate encoding ladder 260 and the corresponding version of the parameter value set 230 in the solution dataset 270. Further, the ILP solver 250 indicates to the parameter search engine 220 that the parameter search engine 220 is to evaluate the new version of the candidate encoding ladder 260 stored in the solution dataset 270.

To initiate each iteration, the parameter search engine 220 generates a new version of the parameter value set 230 based on the solution dataset 270 and the network throughput CDF 142. The parameter value set 230 specifies a set of parameter values for a set of parameters, where the set of parameter values varies across iterations but the set of parameters does not vary across iterations. As described in greater detail below, each parameter can be associated with the parameterized ILP problem in any technically feasible fashion. Each parameter is associated with a valid range of values. The parameter value set 230 is denoted herein as θ and an indicator matrix for a candidate encoding ladder that is associated with the parameter value set 230 is denoted herein as X_{θ}. Notably, θ and X_{θ} vary across iterations.

In some embodiments, the parameter value set 230 is a set of parameter values for a set of parameters that includes, without limitation, a rung count parameter, a target high quality parameter, a maximum storage footprint parameter, a target high quality parameter, rung-specific maximum bitrate spacing ratio parameters, rung-specific minimum quality spacing parameters, a tradeoff weight associated with a parameterized objective function 246, and a weight distribution parameter associated with at least one of a parameterized proxy QoE metric 242 or a parameterized proxy streaming rate metric 244.

As described previously herein in conjunction with FIG. 1, the rung count parameter is denoted as N and specifies an iteration-specific total number of rungs that are to be included in a candidate encoding ladder. The maximum storage footprint parameter, the target high quality parameter, the rung-specific maximum bitrate spacing ratio parameters, and the rung-specific minimum quality spacing parameters are associated with a constraint set 248. The maximum storage footprint parameter, the rung-specific maximum bitrate spacing ratio parameters, the rung-specific minimum quality spacing parameters, the tradeoff weight, the weight distribution parameter, the parameterized objective function 246, the parameterized proxy QoE metric 242, the parameterized proxy streaming rate metric 244, and the constraint set 248 are described in greater detail below in conjunction with the ILP problem definition engine 240.

For the initial iteration, the parameter search engine 220 can generate the parameter value set 230 in any technically feasible fashion. For instance, the ILP problem definition engine 220 can set a parameter value for each parameter included in the set of parameters to an average value based on the associated valid range. Prior to each subsequent iteration, if the parameter search engine 220 is to evaluate the new version of the candidate encoding ladder 260 stored in the solution dataset 270, then the parameter search engine 220 computes a new set of metric values for a set of metrics based on the new version of the candidate encoding ladder 260, the associated quality scores, and the network throughput CDF 142. The parameter search engine 220 stores the new set of metric values in the solution dataset 270. The new set of metric values is associated with both the new version of the candidate encoding ladder 260 and the corresponding version of the parameter value set 230. The set of metrics can include, without limitation, any number and/or types of metrics that are relevant to streaming QoE and/or CDN efficiency.

In some embodiments, the set of metrics includes, without limitation, the expected streaming quality, the top quality difference, the total storage footprint, and the expected streaming bitrate. The parameter search engine 220 computes a metric value for the expected streaming quality based on the new version of the candidate encoding ladder 260, the subset of the quality scores 138 associated with the candidate encoding ladder 260, and the network throughput CDF 142. The parameter search engine 220 computes a metric value for the top quality difference based on the new version of the candidate encoding ladder 260 and the quality score 138 associated with rung N of the candidate encoding ladder 260. The parameter search engine 220 computes a metric value for the total storage footprint based on the new version of the candidate encoding ladder 260. The parameter search engine 220 computes a metric value for the expected streaming bitrate based on the new version of the candidate encoding ladder 260 and the network throughput CDF 142. As described previously herein in conjunction with FIG. 1, the expected streaming quality, the top quality difference, the total storage footprint, and the expected streaming bitrate can be expressed as, respectively, the equation (2)-the equation (5). The parameter search engine 220 stores

For each non-initial iteration, the parameter search engine 220 generates a new version of the parameter value set 230 based on any number of the candidate encoding ladders and the corresponding version(s) of the parameter value set 230 that are stored in the solution dataset 270. More precisely, the parameter search engine 220 performs one or more search operations on the parameter space based on any number of the sets of metric values (where each set of metric values corresponds to a different candidate encoding ladder) and the corresponding version(s) of the parameter value set 230 that are stored in the solution dataset 270 to generate a new version of the parameter value set 230. The parameter space is defined by the valid ranges of the set of parameters corresponding to the parameter value set 230.

The parameter search engine 220 can perform any number and/or types of search operations to generate a new version of the parameter value set 230. In some embodiments, the parameter search engine 220 implements a combination of multi-armed bandits and Bayesian optimization techniques in an attempt to optimize the set of metrics implemented by the parameter search engine 220. As described above, in some embodiments, the set of metrics implemented by the parameter search engine 220 includes, without limitation, the expected streaming quality, the top quality difference, the total storage footprint, and the expected streaming bitrate.

More precisely, in some embodiments, the goal of the search operations is to find a new version of the parameter value set 230 that will ultimately configure the ILP solver 250 to generate a new version of the candidate encoding ladder 260 that lies on a Pareto front that balances streaming QoE and CDN efficiency. In some embodiments, the parameter search engine 220 solves a parameter search problem that can be expressed as an equation (6):

$${max}_{θ} ( E [ Q ( {X}_{θ} ) ] , - Δ Qtop ( {X}_{θ} ) , - S ( {X}_{θ} ) , - E [ {R}_{θ} ( X ) ] ) \qquad ( 6 )$$

As shown, the ILP problem definition engine 240 includes, without limitation, the parameterized objective function 246, the parameterized proxy QoE metric 242, the parameterized proxy streaming rate metric 244, and the constraint set 248. For each iteration, the ILP problem definition engine 240 defines a new ILP problem based on the version of the parameter value set 230 associated with that iteration, the parameterized objective function 246, the parameterized proxy QoE metric 242, the parameterized proxy streaming rate metric 244, and the constraint set 248.

To generate the new ILP problem for a current iteration, the ILP problem definition engine 240 generates a new objective function (not shown) and an instantiated constraint set (not shown) based on the current version of the parameter value set 230, the parameterized objective function 246, the parameterized proxy QoE metric 242, the parameterized proxy streaming rate metric 244, and the constraint set 248. The ILP problem definition engine 240 then formulates the problem of generating a new version of the candidate encoding ladder 260 as a constrained optimization problem of assigning a subset of the candidate rungs 130 to rungs of a new version of the candidate encoding ladder 260 with an objective of increasing the new objective function subject to the instantiated constraint set. The variables of the new ILP problem are the entries of an iteration-specific indicator matrix (described previously herein in conjunction with FIG. 1). In the context of FIG. 2, X denotes an indicator matrix for a current iteration. As described previously herein, the size and entries of X can vary across iterations.

The parameterized objective function 246 approximates a weighted tradeoff between a QoE when streaming a media title and a streaming rate. In some embodiments, the parameterized objective function 246 is a linear combination of a value for the parameterized proxy QoE metric 242 and a value for the parameterized proxy streaming rate metric 244. As used herein, a “proxy” metric is a measurable indicator that has a close correlation to a different metric of interest that is impractical to measure and/or unsuitable for a given purpose and/or at a particular point-in-time. In that regard, many ILP algorithms that are used to solve ILP problems require convex or differentiable objective functions. Accordingly, metrics that are based on the network throughput CDF 142, such as the expected streaming quality and the expected streaming rate are not suitable for defining the parameterized objective function 246.

The parameterized proxy QoE metric 242 is a proxy for the expected streaming quality metric described previously herein. In some embodiments, the parameterized proxy QoE metric 242 is defined based on W rung weights and the N quality scores associated with the rungs in a candidate encoding ladder. Each of the rung weights is associated with a different rung of the candidate encoding ladder. The parameterized proxy QoE metric 242 for a candidate encoding ladder corresponding to the indicator matrix X is denoted herein as “f_{Q}(X).” The rung weights associated with rungs 1-N of the candidate encoding ladder are denoted herein as w₁-w_{N}, respectively. The parameterized proxy QoE metric 242 can be expressed as an equation (7):

$${f}_{Q} ( X ) = {\sum }_{j = 1}^{N} {w}_{j} {Q}_{j} \qquad ( 7 )$$

The rung weights indicate the relative importance of each of the rungs included in the candidate encoding ladder. In some embodiments, the ILP problem definition engine 240 computes the rung weights based on a parameter value for the weight distribution parameter. The weight distribution parameter is denoted herein as wdist. A parameter value for the weight distribution parameter can vary across iterations and is included in the parameterized value set 230.

In some embodiments, the ILP problem definition engine 240 defines values for the rung weights w₁-w_{N} using equations (8a) and (8b):

$${w}_{j} = w dist ( 1 - {wdist}^{N - j} ) , ∀ j ∈ \{ 2 … N \} \qquad ( 8 a )$$

$${w}_{1} = 1 - {\sum }_{j = 2}^{N} {w}_{j} \qquad ( 8 b )$$

Assigning higher values to rung quality weights associated with higher rungs as per equation (8a) emulates historical streaming statistics indicating that, for a given encoding ladder, the frequency with which each of the rungs is actually selected for streaming by endpoint devices typically increases as the corresponding quality score increases.

The parameterized proxy streaming rate metric 244 is a proxy for the expected streaming rate metric described previously herein. In some embodiments, the parameterized streaming rate metric 244 is defined based on the same rung weights (denoted w₁-w_{N}) as the parameterized proxy QoE metric 242 and the N bitrates associated with the rungs included in a candidate encoding ladder. The parameterized proxy streaming rate metric 244 for a candidate encoding ladder corresponding to the indicator matrix X is denoted herein as “f_{R}(X).” The parameterized proxy streaming rate metric 244 can be expressed as an equation (9):

$${f}_{R} ( X ) = {\sum }_{j = 1}^{N} {w}_{j} {R}_{j} \qquad ( 9 )$$

In some embodiments, the parameterized objective function 246 is defined based on the parameterized proxy QoE metric 242, the parameterized proxy streaming rate metric 244, and the tradeoff weight that is denoted herein as λ. The tradeoff weight is a weight that reflects the importance of reducing the streaming rate versus increasing the QoE associated with a candidate encoding ladder. The ILP problem definition engine 240 uses min-max normalization to ensure that the values for the parameterized proxy QoE metric 242 and the parameterized proxy streaming rate metric 244 are comparable. A parameter value for the tradeoff weight can vary across iterations and is included in the parameterized value set 230. The parameterized objective function 246 for a candidate encoding ladder corresponding to the indicator matrix X can be expressed as an equation (10):

$${max}_{X} {f}_{Q} ( X ) - λ {f}_{R} ( X ) \qquad ( 10 )$$

The constraint set 248 includes any number and/or types of constraints, where each constraint restricts one or more rung assignments when generating a new version of the candidate encoding ladder 160. The constraint set 248 can include any number (including zero or all) of parameterized constraints and any number (including zero or all) of non-parameterized constraints. Each constraint can constrain any number of aspects associated with generating a candidate encoding ladder in any technically feasible fashion.

In some embodiments, the parameterized constraint set 248 includes, without limitation, implicit logical constraints and practical logical constraints. The implicit logical constraints ensure that the set of rung assignments specified via a final “optimized” indicator matrix corresponds to a valid candidate encoding ladder. The practical logical constraints capture restrictions and/or preferences that are associated with any operational aspects of streaming videos. Some examples of operational aspects of streaming videos include the capabilities of endpoint devices, network capacity, a CDN, human perception of visual quality, and the like.

The constraint set 248 includes, without limitation, any number and/or types of constraints. Each constraint is a linear constraint that restricts one or more rung assignments and can be associated with zero or more parameters. Each of the constraints included in the constraint set 248 is also referred to herein as a “ladder constraint.” In some embodiments, the constraint set 248 includes, without limitation, implicit logical constraints and practical logical constraints. The implicit logical constraints ensure that the set of rung assignments specified via a final “optimized” indicator matrix corresponds to a valid encoding ladder. The practical logical constraints capture restrictions and/or preferences that are associated with any operational aspects of streaming videos. Some examples of operational aspects of streaming videos include the capabilities of endpoint devices, network capacity, the CDN 190, human perception of visual quality, and the like.

In some embodiments, the constraint set 248 includes, without limitation, a parameterized rung count constraint, a parameterized rung assignment constraint, a parameterized candidate rung assignment constraint, a parameterized monotonically increasing bitrate constraint, a parameterized maximum storage footprint constraint, a parameterized high quality constraint, a parameterized maximum bitrate spacing ratio constraint, a parameterized minimum quality spacing constraint, a minimum bitrate constraint, a maximum quality spacing constraint, and a required resolution constraint.

The parameterized rung count constraint specifies that the total number of rungs that are included in a candidate encoding ladder is equal to the rung count parameter denoted as N. As noted previously herein, the value for the rung count parameter can vary across iterations and therefore the total number of rungs that are included in a given candidate encoding ladder can be different that the total number of rungs that are included in a different candidate encoding ladder. The size of the indicator matrix X is M×N and therefore can vary across iterations.

The parameterized rung assignment constraint is that exactly one of the candidate rungs 130 is assigned to each rung of a candidate encoding ladder. The parameterized rung assignment constraint can be expressed as an equation (11):

$${\sum }_{i = 1}^{M} {X}_{i , j} = 1 , ∀ j ∈ \{ 1 … N \} \qquad ( 11 )$$

The parameterized candidate rung assignment constraint is that each of the candidate rungs 130 is assigned to at most one rung of a candidate encoding ladder. The parameterized candidate rung assignment constraint can be expressed as an equation (12):

$${\sum }_{j = 1}^{N} {X}_{i , j} \leq 1 , ∀ j ∈ \{ 1 … M \} \qquad ( 12 )$$

The parameterized monotonically increasing bitrate constraint is that the bitrate increases monotonically between rungs. The parameterized monotonically increasing bitrate constraint can be expressed as an equation (13):

$${R}_{j} \leq {R}_{j + 1} , ∀ j = 1 … N - 1 \qquad ( 13 )$$

In accordance with equation (13), rung 1 and rung N of a candidate encoding ladder correspond to the lowest bitrate and the highest bitrate, respectively of the candidate encoding ladder.

Because the storage resources of CDNs are limited, the constraint set 248 includes the parameterized maximum storage footprint constraint. The parameterized maximum storage footprint constraint is that the sum of the total storage footprints for the encoded videos assigned to the rungs of a candidate encoding ladder is less than or equal to a maximum storage footprint parameter that is denoted herein as Smax. A parameter value for the maximum storage footprint parameter can vary across iterations and is included in the parameterized value set 230. As described previously here in conjunction with FIG. 1, the total storage footprint of a candidate encoding ladder associated with a media title can be expressed as the product of the duration of the media title (denoted herein as T) and the sum of the bitrates of the rungs of the candidate encoding ladder. Accordingly, the parameterized maximum storage footprint constraint can be expressed as an equation (14):

$${\sum }_{j = 1}^{N} {R}_{j} T \leq S max \qquad ( 14 )$$

In an effort to ensure that a sufficiently high visual quality is perceived by viewers when streaming a media title over a connection having a relatively high network capacity, the constraint set 248 includes the parameterized high quality constraint. The parameterized high quality constraint is that at least one of the rungs of a candidate encoding ladder specifies a quality score that is greater than or equal to a target high quality parameter that is denoted herein as Qtarget. A parameter value for the target high quality parameter can vary across iterations and is included in the parameterized value set 230. The parameterized high quality constraint can be expressed as an equation (15):

$${\sum }_{i : {q}_{i} \geq Qtarget} {\sum }_{j = 1}^{N} {X}_{i , j} \geq 1 \qquad ( 15 )$$

Because the spacing between consecutive rungs of a candidate encoding ladder determines important playback metrics such as number of rebuffers, quality variation, and video quality, the constraint set 248 includes the parameterized maximum bitrate spacing ratio constraint. The parameterized bitrate spacing constraint is that consecutive rungs of a candidate encoding ladder specify bitrates that are separated by no more than rung-specific maximum bitrate spacing ratio parameters. The parameterized maximum bitrate spacing ratio constraint can be expressed as an equation (16):

$${R}_{j + 1} \leq {φ}_{j} {R}_{j} , ∀ j = 1 … N - 1 , \\ where {φ}_{j} denotesamaximumbitratespacingratioparameterforarung \qquad ( 16 )$$

To avoid including redundant rungs in a candidate encoding ladder, the constraint set 248 includes the parameterized minimum quality spacing constraint. The parameterized minimum quality spacing constraint is that consecutive rungs of a candidate encoding ladder specify quality scores that are separated by at least a run-specific minimum quality spacing parameter. The parameterized minimum quality spacing constraint can be expressed as an equation (17):

$${Q}_{j + 1} - {Q}_{j} \geq Δ Qm i {n}_{j} , ∀ j = 1 … N - 1 , \\ where Δ Qmi {n}_{j} denotesaminimumqualityspacingparameterforarung \qquad ( 17 )$$

In an effort to ensure uninterrupted playback of the media title under challenging network conditions, the constraint set 248 includes the minimum bitrate constraint. The minimum bitrate constraint is that at least one of the candidate rungs 130 assigned to the rungs of a candidate encoding ladder specifies a bitrate within 1.01 times a minimum bitrate denoted Rmin (e.g., 100 kbps). The minimum bitrate does not change across iterations. The minimum bitrate constraint constraint can be expressed as an equation (18):

$${\sum }_{i : {r}_{i} \leq 1.01 xRmin} {\sum }_{j = 1}^{N} {X}_{i , j} \geq 1 \qquad ( 18 )$$

To prevent large quality variations, the constraint set 248 includes the maximum quality spacing constraint. The maximum quality spacing constraint is that consecutive rungs of a candidate encoding ladder specify quality scores that are separated by no more than a maximum quality spacing (e.g., 12). The maximum quality spacing is denoted herein as ΔQmax and does not change across iterations. The maximum quality spacing constraint can be expressed as an equation (19):

$${Q}_{j + 1} - {Q}_{j} \leq Δ Q m a x , ∀ j = 1 … N - 1 \qquad ( 19 )$$

Because the screens of different endpoint devices can have different resolutions, the constraint set 248 includes a required resolution constraint. The required resolution constraint is that the rungs of a candidate encoding ladder include at least one rung per required resolution from a set of required resolutions that is denoted as H. The required resolution constraint can be expressed as an equation (20):

$${\sum }_{i : {h}_{i} = {h}_{k}} {\sum }_{j = 1}^{N} {X}_{i , j} \geq 1 , ∀ {h}_{k} ∈ H \qquad ( 20 )$$

For each iteration, the ILP solver 250 executes one or more ILP algorithms on the ILP problem associated with the iteration, the candidate rungs 130, and the quality scores 138 in an attempt to generate a new version of the candidate encoding ladder 260. More specifically, the ILP solver 250 implements any number and/or types of ILP algorithms in an attempt to determine values for the elements of the iteration-specific indicator matrix that optimize the iteration-specific objective function subject to the iteration-specific instantiated set of constraints. Attempting to determine values for an indicator matrix that optimize an objective function subject to an instantiated set of constraints is also referred to herein as “solving” an ILP problem defined by the objective function and the instantiated set of constraints. As used herein, an “ILP algorithm” refers to any type of algorithm that can be used to solve an ILP problem. In some embodiments, the ILP solver 250 implements a branch-and-bound algorithm and/or a cutting-plane algorithm to solve each iteration-specific ILP problem.

As described previously herein, if the ILP solver 250 successfully generates a new version of the candidate encoding ladder 160, then the candidate encoding ladder generator 150 stores the new version of the candidate encoding ladder 260 and the corresponding version of the parameter value set 230 in the solution dataset 270. Further, the ILP solver 250 indicates to the parameter search engine 220 that the parameter search engine 220 is to generate a new set of metric values for the new version of the candidate encoding ladder 260 that is included in the solution dataset 270 prior to initiating a new iteration.

The parameter search engine 220 can determine whether to initiate a new iteration in any technically feasible fashion based on any number and/or types of criteria. For instance, in some embodiments, the parameter search engine 220 continues to initiate new iterations until reaching a total number of iterations, where the total number of iterations is specified via a user interface. In some other embodiments, the parameter search engine 220 continues to initiate new iterations until the solution dataset 270 includes a total number of candidate encoding ladders, where the total number of candidate encoding ladders is specified via a user interface.

Many modifications and variations on the functionality of the candidate encoding ladder generator 150, the parameterized search engine 220, the parameter value set 230, the ILP problem definition engine 240, the parameterized proxy QoE metric 242, the parameterized proxy streaming rate metric 244, the parameterized objective function 246, the constraint set 248, the ILP solver 250, the candidate encoding ladder 260, and the solution dataset 270 will be apparent to those of ordinary skill in the art without departing from the scope and spirit of the described embodiments.

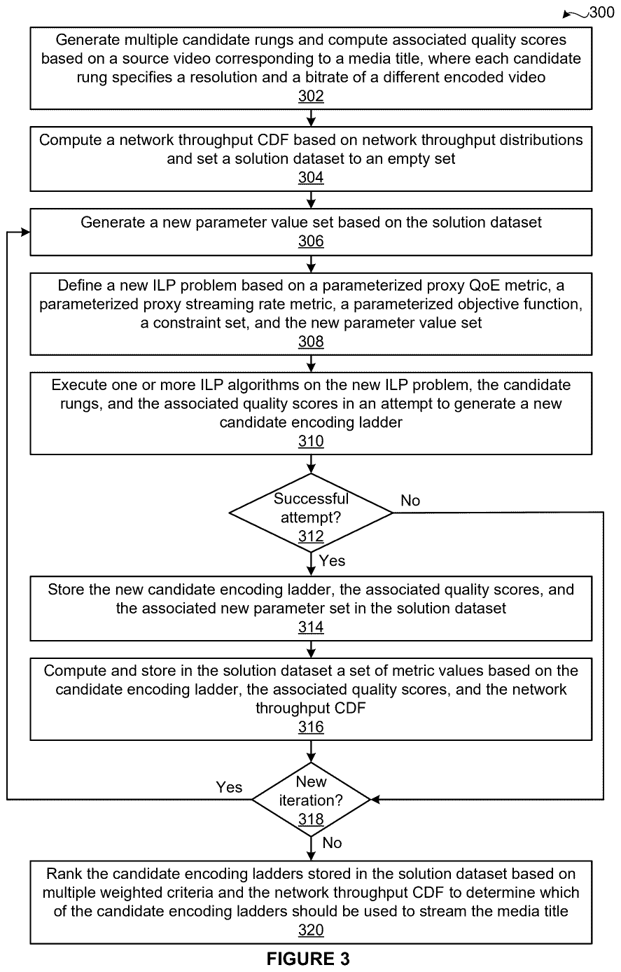

FIG. 3 is a flow diagram of method steps for generating an encoding ladder for a media title, according to various embodiments. Although the method steps are described with reference to the systems of FIGS. 1-2, persons skilled in the art will understand that any system configured to implement the method steps, in any order, falls within the scope of the embodiments.

As shown, a method 300 begins at step 302, where the shot-based encoding application 122 generates multiple candidate rungs and computes associated quality scores based on source video 102 corresponding to a media title, where each candidate rung specifies a resolution and a bitrate of a different encoded video. At step 304, the encoding ladder generation application 140 computes network throughput CDF 142 based on network throughput distributions 108 and the candidate encoding ladder generator 150 sets solution dataset 270 to an empty set.

At step 306, the parameter search engine 220 generates a new parameter value set based on the solution dataset 270. At step 308, the ILP problem definition engine 240 defines a new ILP problem based on parameterized proxy QoE metric 242, parameterized proxy streaming rate metric 244, parameterized objective function 246, constraint set 248, and the new parameter value set. At step 310, the ILP solver 250 executes one or more ILP algorithms on the new ILP problem, the candidate rungs, and the associated quality scores in an attempt to generate a new candidate encoding ladder.

At step 312, the candidate encoding ladder generator 150 determines whether the attempt to generate the new candidate encoding ladder was a successful attempt. If, at step 312, the candidate encoding ladder generator 150 determines that the attempt to generate the new candidate encoding ladder was not a successful attempt, then the method 300 proceeds directly to step 318.

If, however, at step 312, the candidate encoding ladder generator 150 determines that the attempt to generate the new candidate encoding ladder was a successful attempt, then the method 300 proceeds to step 314. At step 314, the candidate encoding ladder generator 150 stores the new candidate encoding ladder, the associated quality scores, and the associated new parameter set in the solution dataset 270. At step 316, the parameter search engine 220 computes and stores in the solution dataset 270 a set of metric values based on the candidate encoding ladder, the associated quality scores, and the network throughput CDF 142.

At step 318, the parameter search engine 220 determines whether to initiate a new iteration. If, at step 318, the parameter search engine 220 determines to initiate a new iteration, then the method 300 returns to step 306, where the parameter search engine 220 generates a new parameter value set based on the solution dataset 270.

If, however, at step 318, the parameter search engine 220 determines not to initiate a new iteration, then the method 300 proceeds to step 320. At step 320, the ladder selection application 170 ranks the candidate encoding ladders stored in the solution dataset 270 based on multiple weighted criteria and the network throughput CDF 142 to determine which of the candidate encoding ladders should be used to stream the media title. The method 300 then terminates.

In sum, the disclosed techniques can be used to iteratively generate an encoding ladder for a media title that inherently represents an overall objective of increasing both the streaming QoE and the CDN efficiency associated with the encoding ladder while concurrently satisfying multiple constraints. In some embodiments, a shot-based encoding application performs one or more encoding operations on a source video corresponding to the media title to generate an overall convex hill of video bitrate-quality points. Each of the video bitrate-quality points specifies an encoded video, the resolution of the encoded video, the bitrate of the encoded video, and a quality score for the encoded video

An encoding ladder generation application computes an encoding ladder for the media title based on the overall convex hull of video bitrate-quality points, any number of network throughput distributions corresponding to historical streaming sessions, and a multi-criteria weight set. For each video bitrate-quality point included in the overall convex hull, the encoding ladder generation application generates a different candidate rung. Each candidate rung specifies a different encoded video, a resolution of the encoded video, and a bitrate of the encoded video and is associated with the quality score of the encoded video. The encoding ladder generation application computes a network throughput CDF based on the network throughput distributions.

A candidate encoding ladder generator included in the encoding ladder generation application iteratively computes multiple candidate encoding ladders based on the candidate rungs, the quality scores, and the network throughput CDF. The candidate encoding ladder generator includes a parameter search engine, an ILP problem definition engine, and an ILP solver. The candidate encoding ladder generator initializes a solution dataset to an empty set. Prior to all but the initial iteration, the parameter search engine determines whether the ILP solver successfully generated a candidate encoding ladder during an immediately preceding iteration. If the ILP solver successfully generated a candidate encoding ladder during the immediately preceding iteration, then the parameter search engine computes and stores in the solution dataset a set of metric values based on that candidate encoding ladder, the associated quality scores, and the network throughput CDF. To initiate a new iteration, the parameter search engine determines a new set of parameter values for a set of parameters based on any portion of the solution dataset. In particular, for all but the initial iteration, the parameter search engine performs one or more search operations on a parameter space based on at least one set of parameter values and the corresponding set of metric values stored in the solution database to generate a new set of parameter values. The goal of the search operations is to find a new set of parameter values that will ultimately configure the ILP solver to generate a new candidate encoding ladder on a Pareto front that balances streaming QoE and CDN efficiency. In some embodiments, the set of parameters includes, without limitation, a rung count parameter, a maximum storage footprint parameter, a target high quality parameter, maximum bitrate spacing ratio parameters, minimum quality spacing parameters, a tradeoff weight associated with the parameterized objective function, and a weight distribution parameter associated with at least one of a parameterized proxy QoE metric or a parameterized proxy streaming rate metric.

The ILP problem definition engine defines a new ILP problem based on the new set of parameter values, the parameterized proxy QoE metric, the parameterized proxy streaming rate metric, the parameterized objective function, and a set of constraints. The parameterized objective function approximates a tradeoff between a quality of experience and a streaming rate using a linear combination of the parameterized proxy QoE metric and the parameterized proxy streaming rate metric. In some embodiments, the set of constraints include, without limitation, a parameterized rung count constraint, a parameterized maximum storage footprint constraint, a parameterized high quality constraint, a minimum bitrate constraint, a parameterized maximum bitrate spacing ratio constraint, a parameterized minimum quality spacing constraint, a maximum quality spacing constraint, and a required resolution constraint.

The ILP problem definition engine generates a new objective function and a new instantiated set of constraints based on the new set of parameter values, the parameterized proxy QoE metric, the parameterized proxy streaming rate metric, the parameterized objective function, and the set of constraints. The ILP problem definition engine then formulates the problem of generating a new candidate encoding ladder as a constrained optimization problem of assigning a subset of the candidate rungs to rungs of a new candidate encoding ladder with an objective of increasing the new objective function subject to the new instantiated set of constraints. The ILP solver executes an ILP algorithm on the ILP problem, the candidate rungs, and the quality scores in an attempt to generate a new candidate encoding ladder. If the ILP solver successfully generates a new candidate encoding ladder, then the candidate encoding ladder generator stores the new candidate encoding ladder and the new set of parameter values in the solution dataset to finish the iteration.

After the candidate encoding ladder generator finishes executing a final iteration, a ladder selection application included in the encoding ladder generation application implements one or more multi-criteria decision analysis techniques to rank the candidate encoding ladders included in the solution dataset based on multiple criteria weighed in accordance with the multi-criteria weight set and the network throughput CDF. The multiple criteria include, without limitation, an expected streaming quality, an expected streaming bitrate, a storage footprint, and a top quality difference. The ladder selection application designates the highest ranked candidate encoding ladder as an encoding ladder that should be used to stream the media title.

At least one technical advantage of the disclosed techniques relative to the prior art is that, with the disclosed techniques, different candidate encoding ladders for a media title can be iteratively generated based an overall objective of increasing both a streaming QoE and a CDN efficiency while concurrently accounting for different ladder constraints when generating each candidate encoding ladder in the first instance. With such an approach, opportunities to use a single encoded video that satisfies multiple different ladder constraints are automatically identified and exploited when generating each candidate encoding ladder, which can improve the tradeoff between the average visual quality of the media title that is achieved when using the encoded videos specified in the candidate encoding ladder and the total storage footprint of the candidate encoding ladder. Consequently, a streaming QoE/CDN efficiency tradeoff represented by a candidate encoding ladder for a given media title can be substantially improved relative to what can be achieved using prior art techniques. These technical advantages provide one or more technological improvements over prior art approaches.

1. In some embodiments, a computer-implemented method for generating encoding ladders that are used to stream media titles comprises performing one or more encoding operations on a source video corresponding to a first media title to generate a plurality of encoded videos; generating a plurality of candidate rungs based on the plurality of encoded videos; executing an integer linear programming (ILP) algorithm on a first ILP problem and the plurality of candidate rungs to generate a first candidate encoding ladder, wherein the first ILP problem is based on a first set of parameter values for a set of parameters, a parameterized objective function, and a plurality of parameterized constraints; generating a second set of parameter values for the set of parameters based on the first candidate encoding ladder and the first set of parameter values; and executing the ILP algorithm on a second ILP problem and the plurality of candidate rungs to generate a second candidate encoding ladder, wherein the second ILP problem is based on the second set of parameter values, the parameterized objective function, and the plurality of parameterized constraints.

2. The computer-implemented method of clause 1, wherein each candidate rung included in the plurality of candidate rungs specifies a resolution and a bitrate of a different encoded video.

3. The computer-implemented method of clauses 1 or 2, wherein executing the ILP algorithm on the first ILP problem comprises assigning a subset of the plurality of candidate rungs to a plurality of rungs included in the first candidate encoding ladder.

4. The computer-implemented method of any of clauses 1-3, further comprising ranking at least the first candidate encoding ladder and the second candidate encoding ladder based on a plurality of weighted criteria to determine that the first candidate encoding ladder should be used to stream the first media title.

5. The computer-implemented method of any of clauses 1-4, wherein generating the second set of parameter values comprises computing a plurality of metric values based on the first candidate encoding ladder and a plurality of network throughput distributions associated with streaming one or more media titles.

6. The computer-implemented method of any of clauses 1-5, wherein generating the second set of parameter values further comprises performing one or more search operations on a parameter space based on the first set of parameter values and the plurality of metric values.

7. The computer-implemented method of any of clauses 1-6, wherein the plurality of parameterized constraints comprises at least one of a parameterized rung count constraint, a parameterized maximum storage footprint constraint, a parameterized high quality constraint, or a parameterized maximum bitrate spacing ratio constraint.

8. The computer-implemented method of any of clauses 1-7, wherein the set of parameters comprises at least one of a rung count parameter, a maximum storage footprint parameter, a target high quality parameter, a maximum bitrate spacing ratio parameter, or a weight associated with the parameterized objective function.

9. The computer-implemented method of any of clauses 1-8, wherein the parameterized objective function comprises a linear combination of a first value for a parameterized proxy quality of experience metric and a second value for a parameterized proxy streaming rate metric.

10. The computer-implemented method of any of clauses 1-9, wherein the set of parameters comprises a weight distribution parameter associated with at least one of the parameterized proxy quality of experience metric or the parameterized proxy streaming rate metric.

11. In some embodiments, one or more non-transitory computer readable media include instructions that, when executed by one or more processors, cause the one or more processors to generate encoding ladders that are used to stream media titles, by performing the steps of performing one or more encoding operations on a source video corresponding to a first media title to generate a plurality of encoded videos; generating a plurality of candidate rungs based on the plurality of encoded videos; executing an integer linear programming (ILP) algorithm on a first ILP problem and the plurality of candidate rungs to generate a first candidate encoding ladder, wherein the first ILP problem is based on a first set of parameter values for a set of parameters, a parameterized objective function, and a plurality of parameterized constraints; generating a second set of parameter values for the set of parameters based on the first candidate encoding ladder and the first set of parameter values; and executing the ILP algorithm on a second ILP problem and the plurality of candidate rungs to generate a second candidate encoding ladder, wherein the second ILP problem is based on the second set of parameter values, the parameterized objective function, and the plurality of parameterized constraints.

12. The one or more non-transitory computer readable media of clause 11, wherein each candidate rung included in the plurality of candidate rungs specifies a resolution and a bitrate of a different encoded video.

13. The one or more non-transitory computer readable media of clauses 11 or 12, wherein executing the ILP algorithm on the first ILP problem comprises assigning a subset of the plurality of candidate rungs to a plurality of rungs included in the first candidate encoding ladder.

14. The one or more non-transitory computer readable media of any of clauses 11-13, further comprising ranking at least the first candidate encoding ladder and the second candidate encoding ladder based on a plurality of weighted criteria to determine that the first candidate encoding ladder should be used to stream the first media title.

15. The one or more non-transitory computer readable media of any of clauses 11-14, wherein generating the second set of parameter values comprises computing a plurality of metric values based on the first candidate encoding ladder and a cumulative distribution function of network throughput.

16. The one or more non-transitory computer readable media of any of clauses 11-15, wherein the plurality of metric values quantifies at least one of an expected streaming quality or an expected streaming rate associated with the first candidate encoding ladder.

17. The one or more non-transitory computer readable media of any of clauses 11-16, wherein the plurality of parameterized constraints comprises at least one of a parameterized rung count constraint, a parameterized maximum storage footprint constraint, a parameterized high quality constraint, or a parameterized maximum bitrate spacing ratio constraint.

18. The one or more non-transitory computer readable media of any of clauses 11-17, wherein the set of parameters comprises at least one of a rung count parameter, a maximum storage footprint parameter, a target high quality parameter, a maximum bitrate spacing ratio parameter, or a weight associated with the parameterized objective function.

19. The one or more non-transitory computer readable media of any of clauses 11-18, wherein the parameterized objective function approximates a weighted tradeoff between a quality of experience when streaming a media title and a streaming rate.

20. In some embodiments, a system comprises one or more memories storing instructions and one or more processors coupled to the one or more memories that, when executing the instructions, perform the steps of performing one or more encoding operations on a source video corresponding to a first media title to generate a plurality of encoded videos; generating a plurality of candidate rungs based on the plurality of encoded videos; executing an integer linear programming (ILP) algorithm on a first ILP problem and the plurality of candidate rungs to generate a first candidate encoding ladder, wherein the first ILP problem is based on a first set of parameter values for a set of parameters, a parameterized objective function, and a plurality of parameterized constraints; generating a second set of parameter values for the set of parameters based on the first candidate encoding ladder and the first set of parameter values; and executing the ILP algorithm on a second ILP problem and the plurality of candidate rungs to generate a second candidate encoding ladder, wherein the second ILP problem is based on the second set of parameter values, the parameterized objective function, and the plurality of parameterized constraints.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for generating encoding ladders that are used to stream media titles, the method comprising:
performing one or more encoding operations on a source video corresponding to a first media title to generate a plurality of encoded videos;
generating a plurality of candidate rungs based on the plurality of encoded videos;
executing an integer linear programming (ILP) algorithm on a first ILP problem and the plurality of candidate rungs to generate a first candidate encoding ladder, wherein the first ILP problem is based on a first set of parameter values for a set of parameters, a parameterized objective function, and a plurality of parameterized constraints;
generating a second set of parameter values for the set of parameters based on the first candidate encoding ladder and the first set of parameter values; and
executing the ILP algorithm on a second ILP problem and the plurality of candidate rungs to generate a second candidate encoding ladder, wherein the second ILP problem is based on the second set of parameter values, the parameterized objective function, and the plurality of parameterized constraints.

2. The computer-implemented method of claim 1, wherein each candidate rung included in the plurality of candidate rungs specifies a resolution and a bitrate of a different encoded video.

3. The computer-implemented method of claim 1, wherein executing the ILP algorithm on the first ILP problem comprises assigning a subset of the plurality of candidate rungs to a plurality of rungs included in the first candidate encoding ladder.

4. The computer-implemented method of claim 1, further comprising ranking at least the first candidate encoding ladder and the second candidate encoding ladder based on a plurality of weighted criteria to determine that the first candidate encoding ladder should be used to stream the first media title.

5. The computer-implemented method of claim 1, wherein generating the second set of parameter values comprises computing a plurality of metric values based on the first candidate encoding ladder and a plurality of network throughput distributions associated with streaming one or more media titles.

6. The computer-implemented method of claim 5, wherein generating the second set of parameter values further comprises performing one or more search operations on a parameter space based on the first set of parameter values and the plurality of metric values.

7. The computer-implemented method of claim 1, wherein the plurality of parameterized constraints comprises at least one of a parameterized rung count constraint, a parameterized maximum storage footprint constraint, a parameterized high quality constraint, or a parameterized maximum bitrate spacing ratio constraint.

8. The computer-implemented method of claim 1, wherein the set of parameters comprises at least one of a rung count parameter, a maximum storage footprint parameter, a target high quality parameter, a maximum bitrate spacing ratio parameter, or a weight associated with the parameterized objective function.

9. The computer-implemented method of claim 1, wherein the parameterized objective function comprises a linear combination of a first value for a parameterized proxy quality of experience metric and a second value for a parameterized proxy streaming rate metric.

10. The computer-implemented method of claim 9, wherein the set of parameters comprises a weight distribution parameter associated with at least one of the parameterized proxy quality of experience metric or the parameterized proxy streaming rate metric.

11. One or more non-transitory computer readable media including instructions that, when executed by one or more processors, cause the one or more processors to generate encoding ladders that are used to stream media titles, by performing the steps of:
performing one or more encoding operations on a source video corresponding to a first media title to generate a plurality of encoded videos;
generating a plurality of candidate rungs based on the plurality of encoded videos;
executing an integer linear programming (ILP) algorithm on a first ILP problem and the plurality of candidate rungs to generate a first candidate encoding ladder, wherein the first ILP problem is based on a first set of parameter values for a set of parameters, a parameterized objective function, and a plurality of parameterized constraints;
generating a second set of parameter values for the set of parameters based on the first candidate encoding ladder and the first set of parameter values; and
executing the ILP algorithm on a second ILP problem and the plurality of candidate rungs to generate a second candidate encoding ladder, wherein the second ILP problem is based on the second set of parameter values, the parameterized objective function, and the plurality of parameterized constraints.

12. The one or more non-transitory computer readable media of claim 11, wherein each candidate rung included in the plurality of candidate rungs specifies a resolution and a bitrate of a different encoded video.

13. The one or more non-transitory computer readable media of claim 11, wherein executing the ILP algorithm on the first ILP problem comprises assigning a subset of the plurality of candidate rungs to a plurality of rungs included in the first candidate encoding ladder.

14. The one or more non-transitory computer readable media of claim 11, further comprising ranking at least the first candidate encoding ladder and the second candidate encoding ladder based on a plurality of weighted criteria to determine that the first candidate encoding ladder should be used to stream the first media title.

15. The one or more non-transitory computer readable media of claim 11, wherein generating the second set of parameter values comprises computing a plurality of metric values based on the first candidate encoding ladder and a cumulative distribution function of network throughput.

16. The one or more non-transitory computer readable media of claim 15, wherein the plurality of metric values quantifies at least one of an expected streaming quality or an expected streaming rate associated with the first candidate encoding ladder.

17. The one or more non-transitory computer readable media of claim 11, wherein the plurality of parameterized constraints comprises at least one of a parameterized rung count constraint, a parameterized maximum storage footprint constraint, a parameterized high quality constraint, or a parameterized maximum bitrate spacing ratio constraint.

18. The one or more non-transitory computer readable media of claim 11, wherein the set of parameters comprises at least one of a rung count parameter, a maximum storage footprint parameter, a target high quality parameter, a maximum bitrate spacing ratio parameter, or a weight associated with the parameterized objective function.

19. The one or more non-transitory computer readable media of claim 11, wherein the parameterized objective function approximates a weighted tradeoff between a quality of experience when streaming a media title and a streaming rate.

20. A system comprising:
one or more memories storing instructions; and
one or more processors coupled to the one or more memories that, when executing the instructions, perform the steps of:
performing one or more encoding operations on a source video corresponding to a first media title to generate a plurality of encoded videos;
generating a plurality of candidate rungs based on the plurality of encoded videos;
executing an integer linear programming (ILP) algorithm on a first ILP problem and the plurality of candidate rungs to generate a first candidate encoding ladder, wherein the first ILP problem is based on a first set of parameter values for a set of parameters, a parameterized objective function, and a plurality of parameterized constraints;
generating a second set of parameter values for the set of parameters based on the first candidate encoding ladder and the first set of parameter values; and
executing the ILP algorithm on a second ILP problem and the plurality of candidate rungs to generate a second candidate encoding ladder, wherein the second ILP problem is based on the second set of parameter values, the parameterized objective function, and the plurality of parameterized constraints.
